(19) United States
(12) Patent Application Publication
(10) Pub. No.: US 2008/0298682 A1
(43) Pub. Date: Dec. 4, 2008

(54) Method a System and a Computer Program for Segmenting a Structure Associated with a Reference Structure in an Image

(75) Inventors: Christian Adrian Cocosco, Hamburg (DE); Gunnar Kedenburg, Hamburg (DE); Wiro Joep Niessen, Rotterdam (NL); Henrik Thoms, Berlin (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/095,370

(22) PCT Filed: Nov. 27, 2006
(86) PCT No.: PCT/IB2006/054452

§ 371 Date: May 29, 2008

(30) Foreign Application Priority Data
Dec. 1, 2005 (EP) 05111566.5

(51) Int. Cl. G06K 9/34

(52) U.S. Cl. 382/173

(57) ABSTRACT

The invention relates to a method of image segmentation for delineating a structure associated with a reference structure in an image. For this purpose a segmentation of the reference structure is accessed. The appearance of different tissue types is learned using the model by non parametric robust estimation that employs a fuzzy kNN classifier in two stages (outlier reduction and final estimation). The model is used to provide seed points for the segmentation. The graph cut method is adapted to perform segmentation of the sought structure. The invention further relates to a system and a computer program for image segmentation.

The invention relates to a method of image segmentation for delineating a structure associated with a reference structure.

The invention further relates to a system for image segmentation of a structure associated to a reference structure in an image.

The invention still further relates to a computer program for image segmentation of a structure associated to a reference structure in an image.

An embodiment of the method as is set forth in the opening paragraph is known from US2003/0069494 A1. In the known method a myocardium contour is determined for two-dimensional images obtained using magnetic resonance imaging technique. The myocardium contour is obtained according to a graph cut of candidate endocardium contours and a spline fitting to candidate epicardium contours in the absence of shape propagation. The known method further includes applying a plurality of shape constrains to candidate endocardium contours and candidate epicardium contours to determine the myocardium contour, wherein a template is determined by shape propagation of a plurality of diagnostic images of the heart.

It is a disadvantage of the known method that in order to perform segmentation of the structure, notably the myocardium, it is required to perform elaborated calculus using a-priori established shape and motion constrains for the reference structures (endocardium and epicardium), which requires substantial manual efforts.

It is an object of the invention to provide a method for segmenting a structure associated to a reference structure in an image, yielding more robust results.

To this end the method according to the invention comprises the following steps:
accessing spatial delineation of the reference structure;
fitting a model representative of the structure to the reference structure based on a-priori established assumptions yielding initial seeds for segmentation of the structure;
estimating an appearance of the structure using a probabilistic method yielding a probability image for the structure; segmenting the structure based on the said probability image and the said initial seeds.

The technical measure of the invention is based on the insight that provided spatial delineation of the reference structure, for example the left and the right ventricles of the heart, notably obtained by an automatic segmentation, the associated structure, notably the myocardium, can easily be segmented, for example based on a simple topological model. The reference structure is identified on the basis of anatomical information, e.g. as is obtained from an anatomical atlas. The method according to the invention uses no shape and motion constrains, is applicable to two-, three- and four-dimensional data and is therefore more robust and precise than the method known from US2003/0069494 A1. It is noted that both US2003/0069494 A1 and U.S. Pat. No. 6,757,414b1 also use some probabilistic methods to estimate the appearance of the structure; however their methods are not robust with respect to outliers (noise in data), and are not well suited to magnetic resonance imaging data. The present invention achieves robustness due to the combination of the probabilistic method with the initial seeds that in a deterministic way indicate portions of the structure. On the contrary, the method according to the invention is superior, because it is a non-parametric method, and because it only eliminates the overlap between the appearance (image intensity) of the tissues of interest.

Preferably, the topological model is constructed using a-priori established assumptions, like a spatial interrelation of the structure and the reference structure. For example, a valid assumption can be based on a fact that the myocardium surrounds the left ventricle of the heart. For other organs, like lungs, kidneys, bladder and rectum other respective geometric or spatial insights can be used. Unlike per se known statistically trained models used in the art of image segmentation, the topological model is preferably not constructed from any training data and is, therefore, not biased towards the population represented in the training set. It is also noted, that the statistically trained models are expensive to obtain. In addition, because the method according to the invention is suitable to be applicable to three- and four-dimensional images, it presents an improved tool for image processing in clinical practice.

Upon an event the model representative of a spatial interrelation between the structure conceived to be segmented and the reference structure is fitted to the image, one obtains a set of initial seeds for the sought structure. Seed points are points that have fixed labels. Notably, these labels identify in a deterministic way if the point at issue belongs to the structure to be segmented. An appearance of the structure is learned from a probabilistic method thereby yielding a probability image of the structure. The probability image represents the probability values of a pixel belonging to the structure. Preferably, a nonparametric robust estimation approach that uses a fuzzy kNN classifier is used. kNN is a per se known classification algorithm. The idea is that, given a training set and a natural number k, a pattern is assigned to the class to which the majority of the k nearest patterns belong. The distance between patterns is a metric in the feature space. Preferably, a “fuzzy” variant of this algorithm is used. Each of the two training sets is represented as a histogram of image intensities. Starting from the sample to be classified, an equidistant wave is simultaneously propagated over the two histograms, until the sum of covered histogram values is at least k for the first time. Typically, the sum of covered histogram values will exceed k. It is important to allow this, because otherwise it would be unclear which of several possible training samples at the same distance should be chosen to complete the set of k nearest samples. The fuzzy kNN function would not be well-defined. But if the number of covered samples can exceed k, the function value can be (and is) defined to be the ratio of foreground training samples in the covered samples to the total number of covered samples. This histogram-based method is fast, but to lose even less time on the classifier evaluation, the function values are computed once for each of the values that can occur in the MR image and then just looked up when the function is actually applied to the whole volume. In order not to introduce a bias into the classifier, the same amount of training samples is drawn for foreground and background. It is noted that it is possible that the classical kNN switches between 0 and 1 more than once between classes. This behavior is undesirable for our application, because additional strong edges might be introduced between voxels of different classes, into the myocardium probability image. Fuzzy kNN does not have this problem improving the robustness of the method. This fuzzy kNN method is preferably applied in two stages, first to eliminate ouliers and then to obtain final estimation of the appearance. Both stages can also be implemented by other per se known computational algorithms.

Making use of the probability image and of the initial seeds, a segmentation of the structure is computed. Preferably, a method known from Y. Boykov, M.-P. Jolly ‘Interactive graph cuts for optimal boundary & region segmentation of objects in N-D images”, ICVV, 2001 is used. More preferably, the graph cut method is adapted to fully automatically compute a segmentation of the left myocardium from the image and the seed points from the model. Graph cut method uses both edge and region based criteria is a robust method because it finds a global optimum instead of a local optimum. Preferably, a special graph is constructed, whereby each voxel in the region of interest is represented by a node in the graph. Additionally, there are two special nodes, called terminal nodes. One terminal node, the source node, represents the segmentation foreground. The other, called sink node, represents the background. Each of the voxel nodes has edges, called n-edges, connecting it to its neighborhood. Preferably, the eight-neighborhood for three spatial dimensions plus time are selected. Except for the n-edges, there are two t-edges for each voxel node, connecting the node to the two terminal nodes. The graph is a flow network. For flow networks, there are efficient algorithms for computing a minimal cut that separates the two terminal nodes. The idea of the graph cut algorithm is that this minimal cut defines a segmentation. A cut that separates the two terminal nodes must leave each node connected to at most one of the terminal edges. A voxel belongs to the class that the still connected terminal node represents. If neither of the terminal edges is connected, both possibilities represent a minimum cut.

Which segmentation corresponds to a minimal cut depends on the choice of edge weights. In the graph cut algorithm, the two different types of edge weights are used to encode two different penalty functions. Dp is a function that defines a penalty for the class membership of point p. It takes two different values, one for each possible label. V_{pq} defines a penalty for assigning different classes to neighboring points p and q. Separating similar points should be penalized stronger than separating dissimilar points. The penalty functions are then combined into the graph cut energy functional:

$$E ( L ) = λ {\sum }_{p ∈ P} {D}_{p} ( {L}_{p} ) + ( 1 - λ ) {\sum }_{( p , q ) ∈ N} {V}_{pq} ( {L}_{p} , {L}_{q} )$$

N is the neighborhood relation on the voxels, P is the set of voxels. In our application, only the voxels in the cardiac region of interest are part of P. As mentioned before, we use the four dimensional eight-neighborhood to make the segmentation consistent along all four axes of the image for greater accuracy in the presence of noisy slices. But any neighborhood can be used: two-dimensional (xy), three-dimensional (xyt or xyz) and four-dimensional (xyzt).

L={Lp|pεP}

L denotes the function that returns for a given voxel of a segmentation the value 1 for foreground and 0 for background. λε [0; 1] is a weighting factor that can be used to shift between the importance of class membership optimality and neighborhood optimality.

Each n-edge in the graph cut graph is represented by exactly one V-type summand of this functional. Every pair of t-edges is represented by exactly one D-type summand. The λ terms are pulled into the penalty functions. All possible penalties are computed and assigned to their respective weights in the flow graph. Because a minimal cut minimizes the sum of edge weights (penalties), it (globally) minimizes the graph cut energy functional.

It is noted that next to the property of the method according to the invention of it being suitable to segment two-, three- and four-dimensional images, it can easily be adapted to new imaging sequences, making it a versatile tool for fast and robust image segmentation. As an additional advantage, the method according to the invention, when applied to cardiac images, provides an improved endocardium contour, thereby still further improving the segmentation of the left ventricle.

The system according to the invention comprises:
an input for accessing a spatial delineation of the reference structure;
a computing means for:
   fitting a model representative of the structure to the reference structure based on a-priori established assumptions yielding initial seeds for segmentation of the structure;
   estimating an appearance of the structure using a probabilistic method yielding a probability image for the structure;
   segmenting the structure based on the said probability image and the said initial seeds.

The system according to the invention enables a fast and versatile segmentation of the structure in diagnostic images, whereby the segmentation can be performed on a broad class of images from different imaging modalities, like ultra-sound, X-ray, magnetic resonance imaging, etc. The system according to the invention also can be used for segmenting two-dimensional, three-dimensional and four-dimensional images of various kinds. Further advantageous embodiments of the system according to the invention are set forth in claims 6 and 7.

The computer program according to the invention comprises instructions for causing the processor to carry out the steps of:
accessing spatial delineation of the reference structure;
fitting a model representative of the structure to the reference structure based on a-priori established assumptions yielding initial seeds for segmentation of the structure;
estimating an appearance of the structure using a probabilistic method yielding a probability image for the structure;
segmenting the structure based on the said probability image and the said initial seeds.

The computer program according to the invention improves a workflow in a hospital environment, as it does not require sophisticated a-priori established models and can be used for segmenting a great variety of structures, provided their spatial relation to a reference structure is known. Examples of the structure versus reference structure comprise, myocardium versus left and right ventricle, esophagus versus lungs, rectum versus bladder and/or prostate gland in males, spinal cord versus vertebrae, etc. Due to the fact that the used model only employs assumptions on spatial interrelation between the sought structure and the reference structure, the computer program can easily be transformed for different anatomic areas and different imaging modalities. Further advantageous embodiments of the computer program according to the invention are set forth in claims 9 and 10.

These and other aspects of the invention will be discussed in further details with reference to figures.

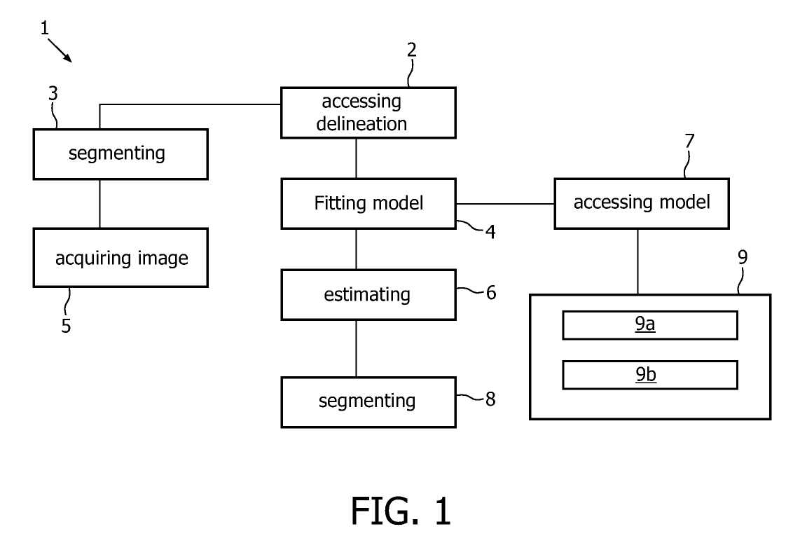

FIG. 1 presents a schematic view of an embodiment of a method according to the invention.

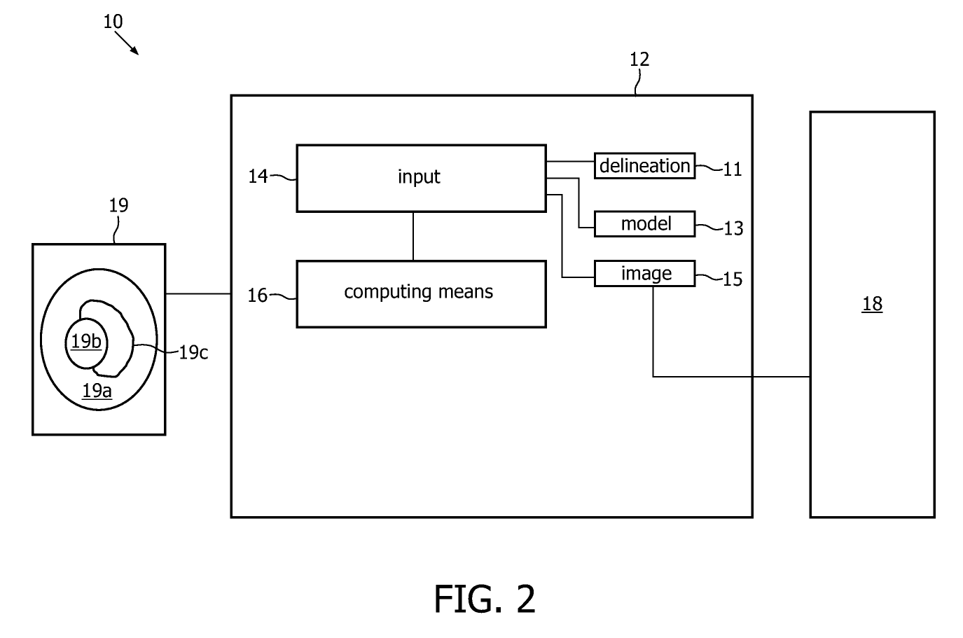

FIG. 2 presents a schematic view of an embodiment of a system according to the invention.

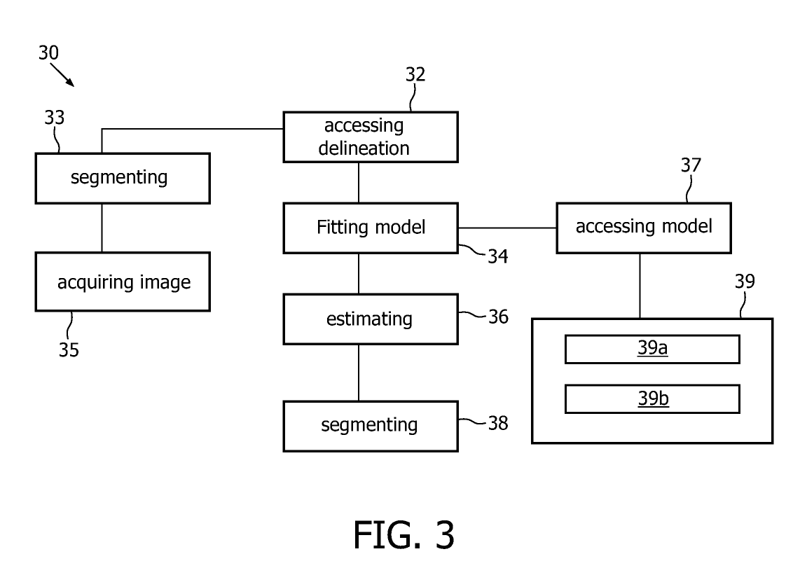

FIG. 3 presents a schematic view of an embodiment of a computer program according to the invention.

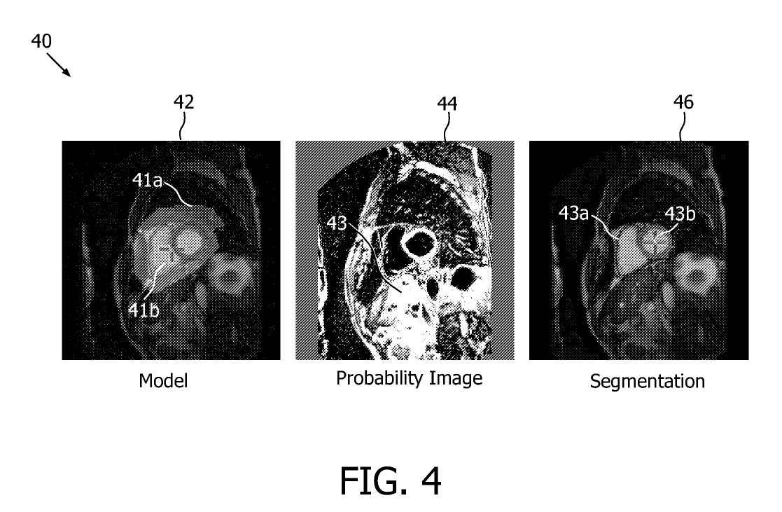

FIG. 4 present in a schematic way an embodiment of image processing results pursuant to the method according to the invention.

FIG. 1 presents a schematic view of an embodiment of a method according to the invention. The method 1 according to the invention, comprise a step of accessing delineation 2 of the reference structure. Preferably, the said delineation 2 is obtained from a previous image segmentation step 3, wherein a suitable image segmentation algorithm has been applied to obtain spatial position of the reference structure in the image. The step 3 of segmenting can be performed a-priori, or immediately before the step 2. Preferably, all data analysis is carried out substantially in real time, following a step 5 of data acquisition using a suitable imaging apparatus. Examples of suitable imaging apparatuses comprise an ultra-sonic device, an X-ray apparatus, a magnetic resonance imaging apparatus, etc. Upon an event the delineation of the reference structure in the image is obtained, the image data are fitted using a model at step 4, notably a topological model of the structure conceived to be segmented in the image, whereby a spatial position of the structure with respect to the reference structure is known with high degree of certainty. The step 4 of fitting the model is preceded by the step 7 of accessing a suitable model representative of the sought structure. Preferably, a plurality of suitable topologic models 9a, 9b are stored in a suitable memory unit 9, each model representative of a certain sought structure, like myocardium, rectum, bladder, kidneys, spinal cord, etc. Upon an event the model is fitted to the image at step 4 the initial seeds of the sought structure in the image are obtained. At step 6 of the method according to the invention an appearance of the sought structure in the image is estimated using a suitable probabilistic method thereby yielding a probability image for the sought structure. The probabilistic method operates using plausible assumptions on the spatial interrelation between the sought structure and the reference structure, for example the assumption that the myocardium surrounds the left ventricle. At step 8 of the method according to the invention the sought structure is segmented using the initial seeds obtained at step 4 and the probability image obtained at step 6. Examples of the operation of the method according to the invention will be discussed with reference to FIG. 4.

FIG. 2 presents a schematic view of an embodiment of a system according to the invention. The system 10 according to the invention comprises a computer 12 arranged with an input 14 for accessing a spatial delineation 11 of the reference structure. Preferably, the said delineation 11 is stored in a suitable memory unit and is obtained during a preparative image processing step, for example a step if image segmentation to yield the said delineation of the reference structure. The input 14 is further arranged to access a model conceived to be fitted to the image data for obtaining initial seed points of the sought structure in accordance with the method of the invention, as was explained with reference to FIG. 1. The image data 15, provided by a suitable data acquisition unit 18 is accessed by the input and can be used to provide the said delineation of the reference structure by application of a suitable image segmentation algorithm. The system 10 according to the invention further comprises a computing mean 16 arranged for fitting a model representative of the structure to the reference structure based on a-priori established assumptions yielding initial seeds for segmentation of the structure, for estimating an appearance of the structure using a probabilistic method yielding a probability image for the structure and for segmenting the structure based on the said probability image and the said initial seeds. Preferably, the system according to the invention further comprises a display unit 19 arranged to display at least the segmentation result 19b of the sought structure. More preferably, the segmentation results 19b are presented together with the delineation of the reference structure 19c and are overlaid on the original image 19 data using a suitable color-shading technique.

FIG. 3 presents a schematic view of an embodiment of a computer program according to the invention. The computer program 30 according to the invention, comprises a first instruction for causing a processor to access delineation 32 of the reference structure. Preferably, the computer program 30 comprises an instruction for obtaining the said delineation 32 from a previous image segmentation step 33, wherein a suitable image segmentation algorithm has been applied to obtain spatial position of the reference structure in the image using a suitable computer algorithm. The segmentation step 33 can be performed a-priori, or immediately before an implementation of the instruction 32. Preferably, all data analysis is carried out substantially in real time, following a step 35 of data acquisition using a suitable computer instruction which operates a suitable imaging apparatus. Examples of suitable imaging apparatuses comprise an ultra-sonic device, an X-ray apparatus, a magnetic resonance imaging apparatus, etc. Upon an event the delineation of the reference structure in the image is obtained, the computer program 30 follows to a further instruction 34 whereby image data are fitted using a model at step 34, notably a topological model of the structure conceived to be segmented in the image, whereby a spatial position of the structure with respect to the reference structure is known with high degree of certainty. The instruction 34 of fitting the model is preferably preceded by the instruction 37 of accessing a suitable model representative of the sought structure. Preferably, a plurality of suitable topologic models 39a, 39b are stored in a suitable memory unit 39, each model representative of a certain sought structure, like myocardium, rectum, bladder, kidneys, spinal cord, etc. Upon an event the model is fitted to the image following the instruction 34 the initial seeds of the sought structure in the image are obtained. A further instruction 36 of the computer program according to the invention causes the processor to estimate an appearance of the sought structure in the image using a suitable probabilistic method thereby yielding a probability image for the sought structure. The probabilistic method operates using plausible assumptions on the spatial interrelation between the sought structure and the reference structure, for example the assumption that the myocardium surrounds the left ventricle. Following the instruction 38 of the computer program according to the invention the sought structure is segmented using the graph cut method explained with reference to the foregoing. Examples of the operation of the method according to the invention will be discussed with reference to FIG. 4.

FIG. 4 present in a schematic way an embodiment of image processing results pursuant to the method according to the invention. The data processing 40 can be schematically separated into three steps. First, at step 42, image data are accessed, and a model representative of the spatial interrelation of the sought structure 41b and the reference structure 41a is applied to the image data. After this, at step 44 the probabilistic image of the sought structure 43 is obtained by application of a probabilistic method for estimating appearance of the sought structure. For example, a fuzzy kNN classifier can be used. At step 46, the segmentation of the sought structure is performed, whereby the results of the step 42 and the step 44 are combined, yielding segmentation of the sought structure 43a (myocardium) related to the segmentation of the reference structure 43b (the left ventricle). An applicability of the method according to the invention to patient data has been investigated. For this purpose 11 clinical balanced FFE cine cardiac MRI data (image size 256×256×10×20, spatial resolution 1.5×1.5×8 mm). An automatically segmented myocardium volume was compared to the volume of manual segmentations performed by a radiologist for two cardiac phases per data set; the RMS error was 12 mL, which is comparable to the inter-rater error. The runtime was only about 30-40 s on one processor of an Intel Xeon 2.4 GHz machine (2 years old technology), for segmenting the complete time series, demonstrating the speedy operation of the image segmentation method according to the invention.

1. A method of image segmentation for delineating a structure associated with a reference structure, comprising:
accessing spatial delineation of the reference structure;
fitting a model representative of the structure to the reference structure based on a-priori established assumptions yielding initial seeds for segmentation of the structure;
estimating an appearance of the structure applying a probabilistic method to the structure yielding a probability image for the structure;
segmenting the structure based on the said probability image and the said initial seeds.

2. A method according to claim 1, wherein the model comprises a topological model.

3. A method according to claim 1, wherein the spatial delineation of the reference structure is performed by means of image segmentation.

4. A method according to claim 3, wherein the reference structure comprises the left and the right ventricle of the heart and the structure comprises the myocardium.

5. A system for image segmentation, comprising:
an input for accessing a spatial delineation of the reference structure;
a computing means for:
fitting a model representative of the structure to the reference structure based on a-priori established assumptions yielding initial seeds for segmentation of the structure;
estimating an appearance of the structure using a probabilistic method yielding a probability image for the structure;
segmenting the structure based on the said probability image and the said initial seeds.

6. A system according to claim 5, wherein the input is further arranged for accessing an image conceived to be segmented, the computing means being further arranged for segmenting the reference structure in the image.

7. A system according to claim 5, wherein the system further comprises a display unit for displaying at least the segmented structure and/or a data acquisition unit arranged for acquiring image data.

8. A computer readable media comprising a computer program comprising instructions for causing a processor to carry out the steps of:
accessing spatial delineation of the reference structure;
fitting a model representative of the structure to the reference structure based on a-priori established assumptions yielding initial seeds for segmentation of the structure;
estimating an appearance of the structure using a probabilistic method yielding a probability image for the structure;
segmenting the structure based on the said probability image and the said initial seeds.

9. (canceled)

10. (canceled)

11. A method according to claim 2, wherein the topological model is based on a spatial interrelation between the structure and the reference structure.

12. A system according to claim 6, wherein the model comprises a topological model, based on a spatial interrelation between the structure and the reference structure.
